(19) United States
(12) Patent Application Publication
(10) Pub. No.: US 2023/0361410 A1
(43) Pub. Date: Nov. 9, 2023

(54) PORTABLE AND MODULAR BATTERY SYSTEM

(71) Applicant: Enphase Energy, Inc., Petaluma, CA (US)

(72) Inventors: David Garrett STANTON, Austin, TX (US); Christopher McNair LYKE, Austin, TX (US)

(21) Appl. No.: 18/140,875

(22) Filed: Apr. 28, 2023

Related U.S. Application Data
(60) Provisional application No. 63/338,088, filed on May 4, 2022.

(51) Int. Cl. H01M 50/258; H02M 7/00; H01M 50/244; H01M 50/284; H02J 7/00; H01M 10/6563

(52) U.S. Cl. CPC H01M 50/258; H02M 7/003; H01M 50/244; H01M 50/284; H02J 7/0045; H01M 10/6563

(57) ABSTRACT

A battery system comprising an enclosure having a first end, a second end and a housing extending between the first end and the second end to define a space within the enclosure. At least one opening defined by the first end of the enclosure such that the at least one opening accommodates a plurality of removable power modules. A plurality of input/output connectors are positioned on the enclosure to couple DC and AC power to and from the enclosure. A circuit board is positioned in the enclosure to distribute the AC and DC power between the plurality of input/output connectors and the removeable power modules. Each removeable power module is a standalone power module that forms an AC and/or DC power source separate from the enclosure or, alternatively, when coupled to the enclosure, forms a multiple power module battery system.

### RELATED APPLICATION

This application claims benefit to U.S. Provisional Patent Application Ser. No. 63/338,088 filed 4 May 2022 entitled “Portable and Modular Battery System,” which is hereby incorporated herein by reference in its entirety.

### BACKGROUND

### Field

Embodiments of the present invention generally relate to energy storage systems and, in particular, to a portable and modular battery system.

### Description of the Related Art

Portable energy storage systems comprise at least one battery and circuitry to charge and discharge the at least one battery. The charging circuit may include an external power converter to convert 120/240 VAC power to 12/28 VDC power. The DC voltage is then applied to the at least one battery to charge the battery. The discharge circuitry generally comprises an inverter to convert the battery DC power to an AC output, e.g., 120 VAC or 240 VAC.

Currently available portable battery systems are a single storage unit with a charge/discharge circuit. There is no modularity to enable the system to be adapted to various use cases, i.e., campground lighting, laptop charging, appliance power during a blackout, etc. Each use case may require different amounts of power. A single, non-modular system may have too much power for some use cases (laptop charging) or too little power in other use cases (powering a refrigerator during a blackout).

Therefore, there is a need for a portable and modular battery storage system that flexibly connects to DC and AC sources and uses modular sub-systems that may be independently charged and discharged.

### SUMMARY

A portable and modular battery storage system is provided substantially as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present invention can be understood in detail, a particular description of the invention, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a perspective view of a portable and modular battery storage system in accordance with at least one embodiment of the invention;

FIG. 2 depicts a cutaway view of a portable and modular battery storage system in accordance with an embodiment of the invention;

FIG. 3 depicts a perspective view of the portable and modular battery storage system having a power module partially removed from the system housing in accordance with an embodiment of the invention; and

FIG. 4 depicts a perspective view of a power module in accordance with an embodiment of the invention;

FIG. 5 depicts a top plan view of the power module in accordance with an embodiment of the invention; and

FIG. 6 depicts a cutaway view of the power module in accordance with an embodiment of the invention.

### DETAILED DESCRIPTION

Embodiments of the present invention comprise a portable and modular battery storage system. The system comprises a main enclosure for supporting a plurality of removeable power modules. Each module may be charged and discharged separate from the main enclosure and features AC, DC, USB and solar power connectors. In one particular embodiment, a module may comprise USB-C and AC connectors. Alternatively, the power modules may be inserted into the main enclosure and charged via electronics in the main enclosure. The main enclosure also features AC, DC, USB and solar power connectors.

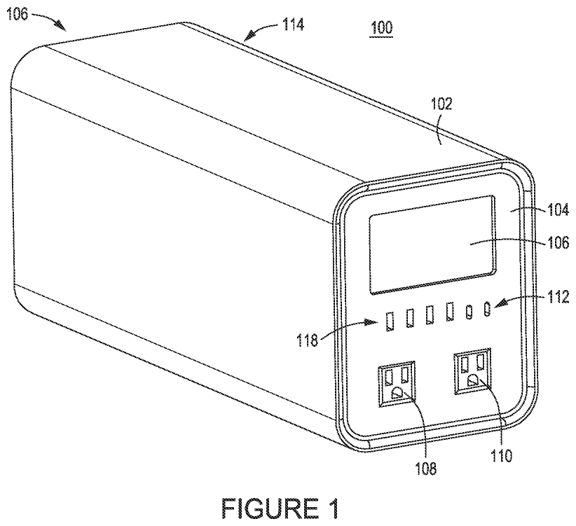

FIG. 1 depicts a perspective view of a portable and modular battery storage system 100 in accordance with at least one embodiment of the invention. At least one embodiment comprises a main enclosure 114 having a first end 104 and a second end 106, where the ends 104 and 106 are coupled to one another by an elongated, tubular housing 102. In one embodiment, the housing 102 is a tube with a square cross-section having four rounded corners. In one specific embodiment, the housing 102 has a height of about 192 mm, a length of about 440 mm and a width of about 160 mm. Of course, other sizes and shapes of the main enclosure may be used to form other embodiments. End 104 comprises various connectors, for example, but not limited to, at least one USB-A connector 118, at least one USB-C connector 112, at least one NEMA 5-15 AC outlet 108 and 110, and a visual display of information such as a display screen 116, e.g., an LCD (liquid crystal display) screen, or an array of light emitting diodes (LEDs), or some other form of visual display. The display screen 116 displays information regarding one or more of the system's on/off state, state of charge and discharge, e.g., amount of energy currently stored, and the like. Various system diagnostic data may also be displayed. In other embodiments, there may be no indicator(s) or visual displays at all.

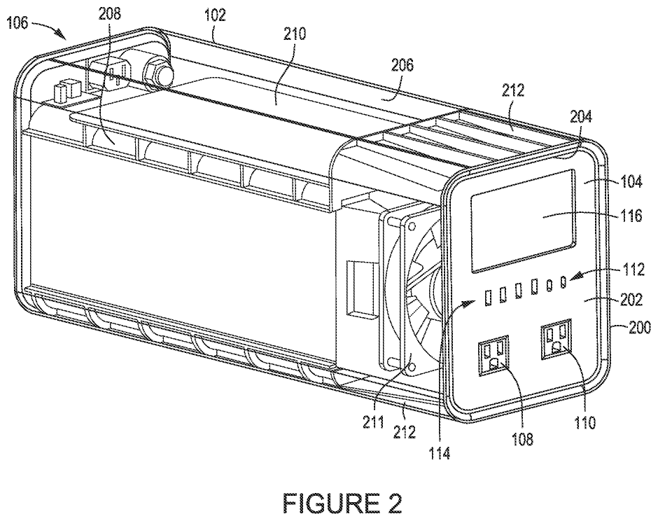

FIG. 2 depicts a cutaway view of the portable and modular battery storage system 100 in accordance with an embodiment of the invention. In one embodiment, the end 104 comprises an outer ring 200 surrounding a substantially planar inner end portion (face) 202 to form a gap 204 in at least a portion of the connected region between the ring 200 and face 202. In one embodiment, the gap 204 is formed at the top and bottom of the face 202. The gap 204 facilitates air flow through the system 100.

The housing 102 defines an interior space 206 within which are supported a plurality of power modules 208, at least one control circuit board 210, a fan 211 and air flow baffles 212. The fan 211 provides air flow to circulate air through the gap 204 and into the baffles 212 which direct the flow of air through internal components of the system 100. The plurality of power modules 208 shall be described in detail below. The at least one control circuit board 210 comprises circuitry for controlling power distribution between the enclosure connectors 108, 110, 112, 118 and the plurality of power modules 208 such that the modules are properly charged and discharged. The at least one control circuit board 210 also controls the fan 210 and the display 116.

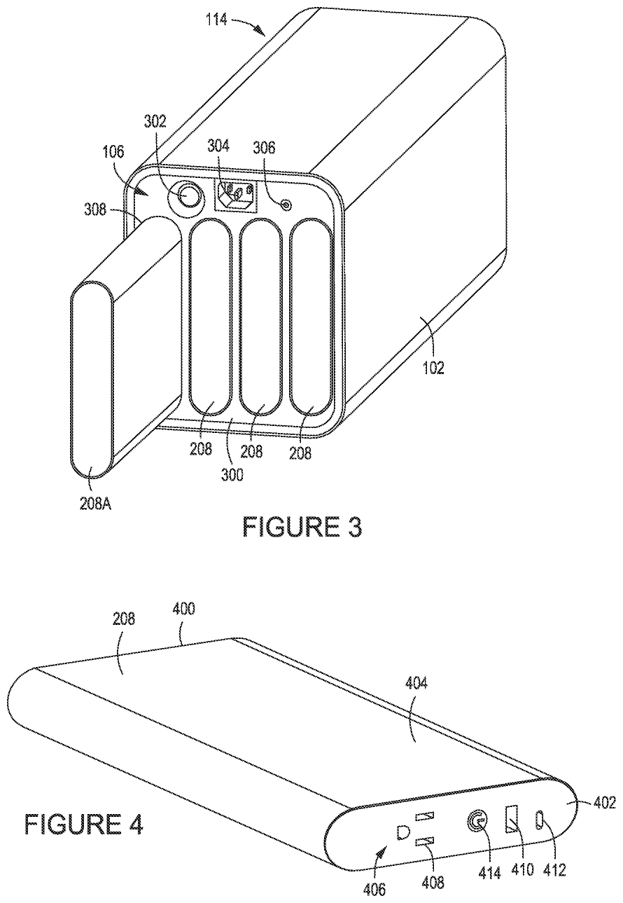

FIG. 3 depicts a perspective view of the portable and modular battery storage system 100 having a power module 208A (i.e., one of four power modules 208) partially removed from the system enclosure 114 in accordance with an embodiment of the invention. Although four power modules 208 are shown, the system 100 may be design to contain any number of power modules 208. In one embodiment, end 106 defines at least one opening 308 through which at least one power module 208 is positioned (i.e., inserted and plugged into the enclosure 114). The at least one opening facilitates ingress and egress of one or more power modules into the enclosure 114. In other embodiments, end 106 may define a plurality of openings 308—one opening for each power module 208. End 106 further comprises input power connectors 302, 304 and 306. In one embodiment, the connectors comprise a solar input connector 302 for connecting to a solar panel or array, an AC power input connector 304 for connecting to the power grid, generator or other source of AC power, and a 12 Volt DC input connector 306 for connecting to a DC power source. Each power module 208 slides into the enclosure 114 along a channel within the enclosure 114. The modular power modules 208 are described in detail below.

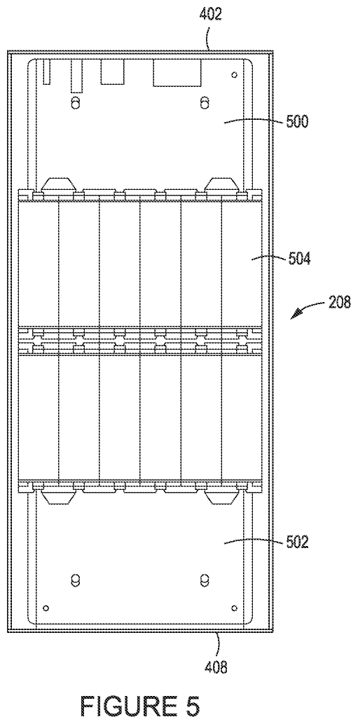

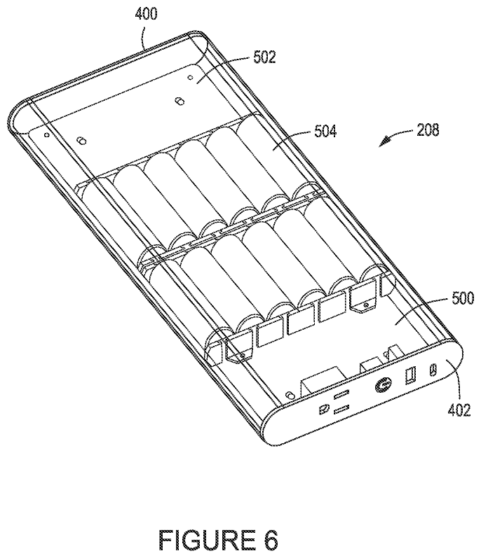

FIG. 4 depicts a perspective view of a power module 208 in accordance with an embodiment of the invention. The power module 208 is defined by a first end 400, a second end 402 and a cylindrical housing 404 having a flat-sided oval cross section that extends from the first end 400 to the second end 402. In other embodiments, the housing 404 may have other cross-sectional shapes, e.g., circular, square, rectangle, etc. The enclosure 114 of FIG. 3 will have openings that match the shape of the housing 404 to facilitate insertion of the power modules 208. The housing 404 encloses at least one battery and charge/discharge circuitry (see FIGS. 5 and 6 as well as the associated description for details). The housing 404 is typically made of a thermally conductive material, e.g., aluminum, to facilitate passive cooling of the at least one battery and circuitry within the housing 404.

One end 402 of the module 208 comprises input/output connectors 406. These connectors 406 may comprises, for example, but are not limited to, one or more of an NEMA 5-15 AC outlet 408, USB Type A connector 410, USB Type C connector 412, and a 12 VDC connector 414. Other connectors for AC and/or DC input/output may be used. These connectors 406 are bidirectional such that they can be used to charge the module 208 or discharge the module 208. Consequently, the module 208 may standalone separately from the enclosure 114 and be operated as a standalone power source. Or, alternatively, the module 208 may be inserted into the system enclosure 114 where the enclosure 114 comprises matching connectors (male connectors) within each channel such that the module 208 may charge or discharge via the enclosure 114. Additionally, circuitry within the enclosure 114 may combine output power of the modules 208 to produce a high power and/or long-lived output at the enclosure connectors 108, 110, 112, 118. In one example, individual modules 208 may be removed and used to light various lights around a campground or charge mobile devices. In other example uses, the modules may be combined into the enclosure 114 to provide a high-power source to power an appliance during a power outage. A module 208 may also be removed when its state of charge is low and, because of its portability, may be carried and charged elsewhere, or swapped instantly with a spare module 208 holding a full charge.

FIG. 5 depicts a top plan view of the power module 208 and FIG. 6 depicts a cutaway view of the power module 208 in accordance with an embodiment of the invention. In one embodiment, a battery pack 504 (plurality of interconnected batteries or battery cells) are mounted centrally within the module 208 to balance product feel. In an exemplary embodiment, circuitry 500 for handling AC power is located at end 402 of the module 208 and circuitry 502 for handling DC power is located at end 400 of the module 208. The battery pack 504 is positioned between the AC and DC circuits 500 and 502.

In one specific exemplary embodiment, the module 208 is approximately 143 mm wide, 314 mm long and 31 mm thick. Such a module may utilize a 200-250 W AC/DC inverter to convert DC to AC and AC to DC in a bidirectional manner. The module may utilize a battery pack comprising nickel-manganese-cobalt (NMC) battery cells with 21700 cells forming each battery in the pack. In one embodiment, the pack 504 may comprise twelve 5 Ah batteries to create a 216 Wh module. One exemplary battery pack may comprise model 50E batteries manufactured by Samsung. Spring terminals may be used to connect the batteries with the pack 504 such that the batteries may be replaced upon failure.

Here multiple examples have been given to illustrate various features and are not intended to be limiting. Any one or more of the features may not be limited to the particular examples presented herein, regardless of any order, combination, or connections described. In fact, it should be understood that any combination of the features and/or elements described by way of example above are contemplated, including any variation or modification which is not enumerated, but capable of achieving the same. Unless otherwise stated, any one or more of the features may be combined in any order.

As above, figures are presented herein for illustrative purposes and are not meant to impose any structural limitations, unless otherwise specified. Various modifications to any of the structures shown in the figures are contemplated to be within the scope of the invention presented herein. The invention is not intended to be limited to any scope of claim language.

Where “coupling” or “connection” is used, unless otherwise specified, no limitation is implied that the coupling or connection be restricted to a physical coupling or connection and, instead, should be read to include communicative couplings, including wireless transmissions and protocols.

Where conditional language is used, including, but not limited to, “can,” “could,” “may” or “might,” it should be understood that the associated features or elements are not required. As such, where conditional language is used, the elements and/or features should be understood as being optionally present in at least some examples, and not necessarily conditioned upon anything, unless otherwise specified.

Where lists are enumerated in the alternative or conjunctive (e.g., one or more of A, B, and/or C), unless stated otherwise, it is understood to include one or more of each element, including any one or more combinations of any number of the enumerated elements (e.g., A, AB, AC, ABC, ABB, etc.). When “and/or” is used, it should be understood that the elements may be joined in the alternative or conjunctive.

While the foregoing is directed to embodiments of the present invention, other and further embodiments of the invention may be devised without departing from the basic scope thereof, and the scope thereof is determined by the claims that follow.

1. A portable and modular battery storage system comprising:
an enclosure having a first end, a second end and a housing extending between the first end and the second end to define a space within the enclosure;
one or more openings defined by the second end of the housing configured to accommodate a plurality of removable power modules;
a plurality of input/output connectors, positioned on the enclosure, configured to couple DC and AC power to and from the enclosure;
a circuit board, positioned in the enclosure, for distributing the AC and DC power between the plurality of input/output connectors and the plurality of removeable power modules;
where each removeable power module in the plurality of removeable power modules is a standalone power module that forms an AC and/or DC power source for use separate from the enclosure or, alternatively, when coupled to the enclosure, forms a multiple power module power system.

2. The portable and modular battery storage system of claim 1, wherein the second end defines a plurality of openings, where each opening is configured for ingress and egress of a removeable power module.

3. The portable and modular battery storage system of claim 1, wherein the first end comprises a display and a plurality of input/output connectors.

4. The portable and modular battery storage system of claim 3, wherein the plurality of input/output connectors comprise at least one USB-A connector, at least one USB-C connector, and/or at least one NEMA 5-15 AC outlet.

5. The portable and modular battery storage system of claim 1, wherein the first end comprises a gap to allow air to flow into the enclosure.

6. The portable and modular battery storage system of claim 1, wherein each removeable power module comprises at least one battery and at least one bidirectional power converter.

7. The portable and modular battery storage system of claim 6, wherein the at least one battery is centrally located within the power module.

8. The portable and modular battery storage system of claim 6, wherein the removeable power module comprises at least one input/output connector.

9. The portable and modular battery storage system of claim 1, wherein energy from each of the removable power modules is combined to form a high-power AC output.

10. The portable and modular battery storage system comprising:
an enclosure having a first end, a second end and a housing extending between the first end and the second end to define a space within the enclosure;
a plurality of openings defined by the second end of the housing configured to accommodate a plurality of removable power modules, wherein each opening enables the ingress and egress of a removeable power module;
a plurality of input/output connectors, positioned on the enclosure, configured to couple DC and AC power to and from the enclosure;
a circuit board, positioned in the enclosure, for distributing the AC and DC power between the plurality of input/output connectors and the plurality of removeable power modules;
where each removeable power module in the plurality of removeable power modules comprises at least one battery and at least one bidirectional power converter configured to form a standalone power module that forms an AC and/or DC power source for use separate from the enclosure or, alternatively, when coupled to the enclosure, forms a multiple power module power system.

11. The portable and modular battery storage system of claim 10, wherein the first end comprises a display and a plurality of input/output connectors.

12. The portable and modular battery storage system of claim 11, wherein the plurality of input/output connectors comprise at least one USB-A connector, at least one USB-C connector, and/or at least one NEMA 5-15 AC outlet.

13. The portable and modular battery storage system of claim 10, wherein the first end comprises a gap to allow air to flow into the enclosure.

14. The portable and modular battery storage system of claim 10, wherein the at least one battery is centrally located within the power module.

15. The portable and modular battery storage system of claim 10, wherein the removeable power module comprises at least one input/output connector.

16. The portable and modular battery storage system of claim 10, wherein energy from each of the removable power modules is combined to form a high-power AC output.

17. The portable and modular battery storage system comprising:
an enclosure having a first end, a second end and a tubular housing extending between the first end and the second end to define a space within the enclosure;
a plurality of openings defined by the second end of the housing configured to accommodate a plurality of removable power modules, wherein each opening enables the ingress and egress of a removeable power module;
a plurality of input/output connectors, positioned on the first end of the enclosure, configured to couple DC and AC power to and from the enclosure;
a display positioned on the first end of the enclosure;
a circuit board, positioned in the enclosure, for distributing the AC and DC power between the plurality of input/output connectors and the plurality of removeable power modules;
where each removeable power module in the plurality of removeable power modules comprises at least one battery and at least one bidirectional power converter configured to form a standalone power module that forms an AC and/or DC power source for use separate from the enclosure or, alternatively, when coupled to the enclosure, forms a multiple power module power system.

18. The portable and modular battery storage system of claim 17, wherein the plurality of input/output connectors comprise at least one USB-A connector, at least one USB-C connector, and/or at least one NEMA 5-15 AC outlet.

19. The portable and modular battery storage system of claim 17, wherein the at least one battery is centrally located within the power module.

20. The portable and modular battery storage system of claim 17, wherein energy from each of the removable power modules is combined to form a high-power AC output.
